(19) United States
(12) Patent Application Publication
(10) Pub. No.: US 2010/0023386 A1
(43) Pub. Date: Jan. 28, 2010

(54) SOCIAL NETWORKING PLATFORM FOR INTELLECTUAL PROPERTY ASSETS

(76) Inventors: SOL AVISAR, Ottawa (CA); GREG WAITE, Ottawa (CA)

Correspondence Address: J. GORDON THOMSON, P.O. BOX 8865, VICTORIA, BC, V8V 3Z1, CA

(21) Appl. No.: 12/507,715

(22) Filed: Jul. 22, 2009

Related U.S. Application Data
(60) Provisional application No. 61/083,142, filed on Jul. 23, 2008.

(51) Int. Cl. G06Q 30/00

(52) U.S. Cl. 705/14.1; 705/26

(57) ABSTRACT

A subscription social networking platform for the purchase and sale of IP assets between two subscribers includes an e-commerce platform, content analysis engine and database for storing vendible IP assets loaded by the subscribers. The content analysis engine determines the category of IP asset being loaded into the database. Any subsequent dialogue between any two subscribers about a particular category of IP asset will cause a search engine to search the database for relevant IP assets in that category for placement on a negotiation list. The two subscribers can thereafter negotiate the sale and purchase of the IP asset in a secure manner.

### CROSS REFERENCE TO RELATED APPLICATIONS

This application is entitled to the benefit of U.S. Provisional Patent Application No. 61/083,142 filed on Jul. 23, 2008.

### FIELD OF THE INVENTION

This invention relates to business practices and more particularly to electronic negotiations and specifically to a social networking platform for intellectual property assets.

### BACKGROUND OF THE INVENTION

The present invention relates to the fields of internet based methods and systems for the trading of intangible knowledge based properties and in particular intellectual property assets. For the purposes of this patent application intellectual property assets includes any form of intellectual property including without limitation patents, trademarks, copyrights and industrial designs.

It is known in the art to provide databases of intellectual property assets and allow for the exchange of intellectual property assets through a global network. It is also known to provide social networking services for persons who share similar interests and characteristics and for managing the information of such persons.

A group of persons comprising those who own or who have an interest in intellectual property assets are well suited for social networking. However, a main limitation of present systems is the lack of a mechanism to bring potentially interested parties together on such an intellectual property social network and motivate them to participate therein. Accordingly, the present invention provides for a collaborative internet based environment for the identification, discussion and evaluation of intellectual property assets pertinent to a community of interested parties. The present invention further provides for the creation of an on-line market for the exchange of intellectual assets in which a variety of interested stakeholders including buyers, sellers, agents and service holders are able and financially motivated to participate.

### SUMMARY OF THE INVENTION

Embodiments of the present invention comprise a social networking platform for IP assets comprising: a market comprising vendors and purchasers of the IP assets and e-commerce means linking vendors with purchasers whereby the vendors upload proprietary IP assets for sale to the platform on a subscription basis. The vendors and purchasers are grouped into interest clusters related to their particular IP interests. There is also provided a categorization engine for categorizing the IP assets into a plurality of searchable categories. Collaboration software permits communication to and between the interest clusters of the presence of IP assets of potential interest that are for sale. The purchasers and vendors access the platform on a subscription basis. There is also included a search engine adapted to identify additional sources of vendible IP assets for interest clusters. Communications means is provided between interest clusters in order that they may discuss the sale of IP assets of interest for a pre-determined and limited period of time. There is a negotiation list upon which IP assets of interest are placed so that vendors and purchasers of the IP assets of interest may negotiate a commercial transaction for a limited period of time. This time can be increased for a fee paid by one or both of the negotiating parties.

### BRIEF DESCRIPTION OF THE DRAWINGS

FIG. 1 is a diagram of the platform and its relationship to holders of IP assets.

FIG. 2 is a diagram of the platform notifying Clustered Interests of relevant IP assets.

FIG. 3 is a diagram of the platform conducting a search for IP assets of third party databases.

FIG. 4 is a diagram of how the platform identifies IP assets of interest during a dialogue.

FIG. 5 is a diagram of a specific IP asset placed on the negotiation list

FIG. 6 is a diagram of the platform searching external databases for a specific IP asset.

FIG. 7 is a diagram of how the platform conducts negotiation with non-subscribers.

FIG. 8 is a diagram of how the platform rates the commercial viability of IP assets.

FIG. 9 is a diagram of how the platform integrates a third party broker and reward platform.

### DESCRIPTION OF THE INVENTION

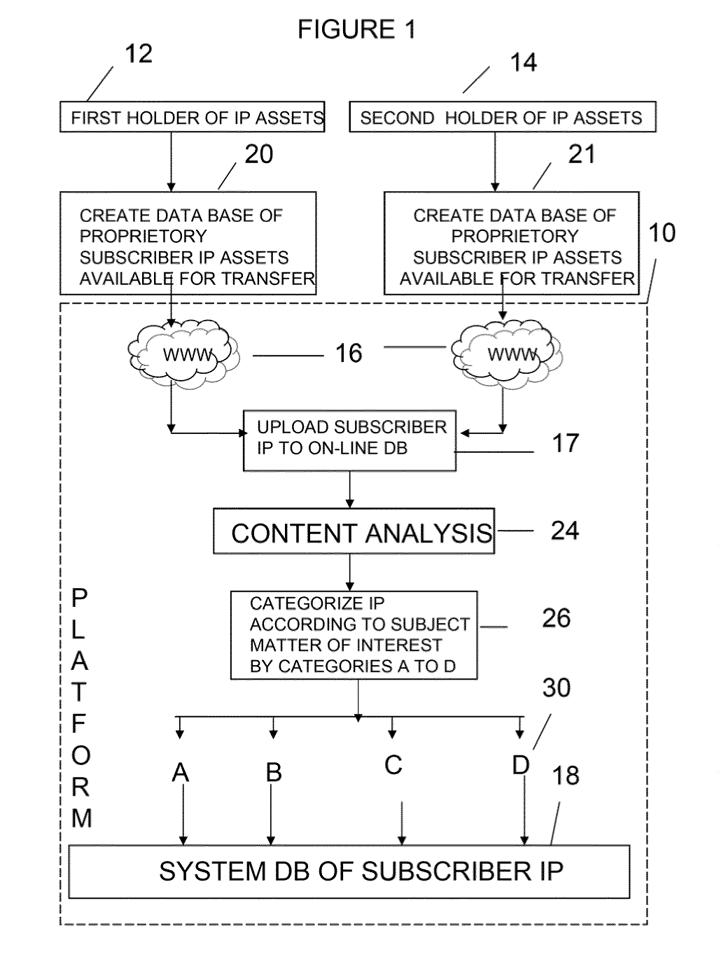

Referring to FIG. 1, and according to the present invention 10 which is a social, networking platform comprising a market comprising buyers and sellers of intellectual property assets, e-commerce means for the purchase and sale for intellectual property assets, holders of intellectual property assets acting as buyers 12 and sellers 14, a website 16 for remotely 17 uploading into the invention platform database 18 any number of intellectual property assets 20 and 21 in which rights are available for acquisition by way sale, license or otherwise (“Subscriber IP”).

The invention further comprises a content analysis engine 24 for content categorization into categories of interest. After uploading, the Subscriber IP is then subject to a content analysis engine 24 and categorized 26 in accordance with their subject matter, 30, which is illustrated as four categories A to D. However, these can represents one of categories of patents, trade-marks, copyright or licensable assets.

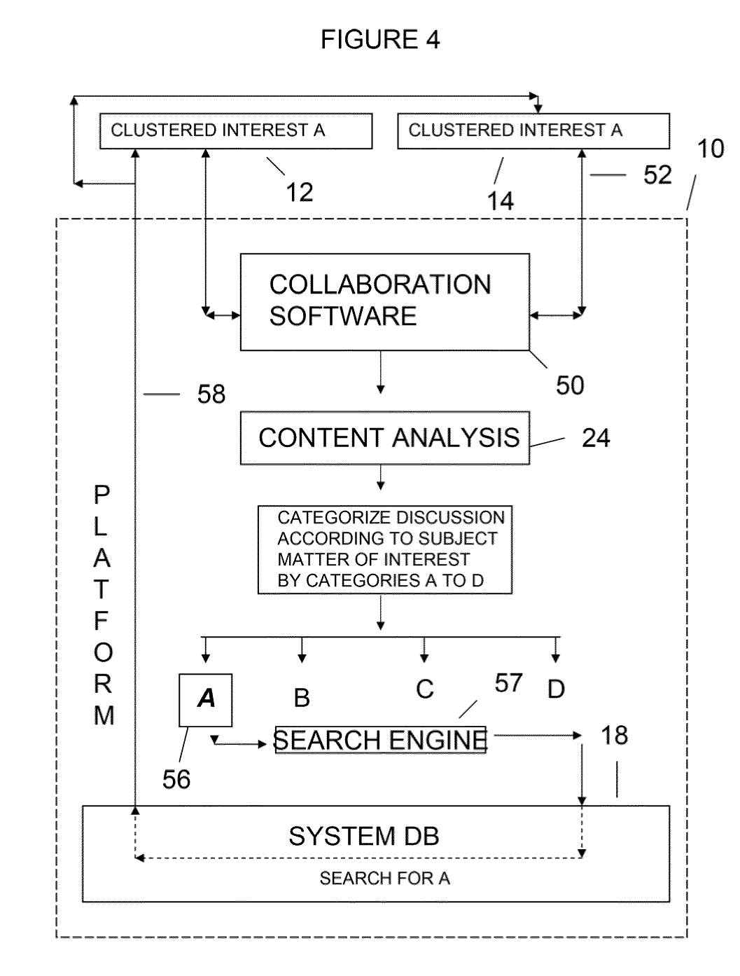

The invention further comprises messaging means in the form of collaboration software (FIG. 4 Item 50) so that die purchaser and seller may communicate and negotiate through the platform the purchase and sale of a particular IP asset in confidence.

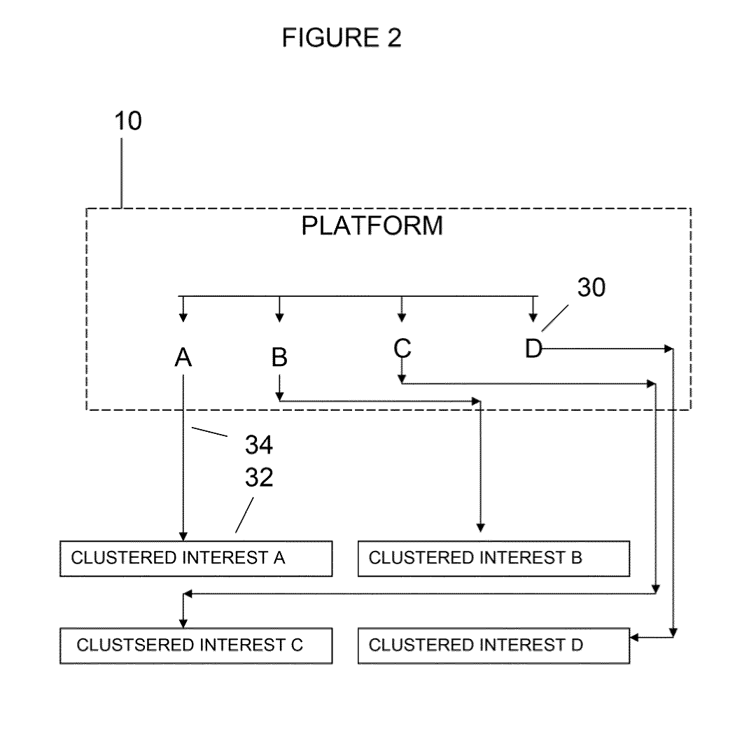

Referring to FIG. 1 and FIG. 2, the platform 10 is able to perform a content analysis by way of engine 24 in respect of a given intellectual property asset and generate one or more categorization suggestions (A to D) that will position the asset in one or more categories (A to D) 30 that the platform has identified to be of interest to specific communities. An on-line community of persons who have an interest in one or more categories to which an intellectual property asset relates is herein referred to as a clustered interest 32.

As intellectual property assets are uploaded to database 18 the platform automatically notifies 34 subscribers 32, based on the clustered interest to which they belong and the nature of the assets, that new assets in specified areas of interest have been added.

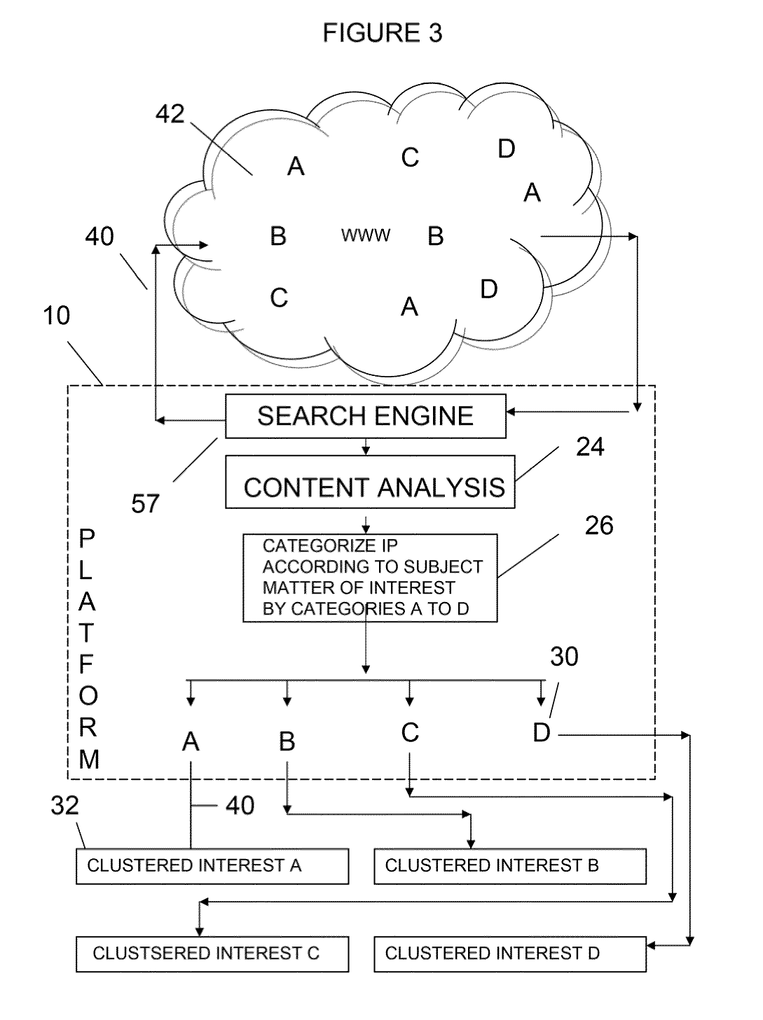

Referring now to FIG. 3, and in addition to passively receiving intellectual property assets from holders of intellectual assets, the platform 10 automatically searches 40 by way of a search engine 57 and harvests intellectual property sources 42 external to the platform 10 based on clustered interests of its users. The harvested IP is content analyzed 24 and categorized 26 according to subject matter 30 of interest by categories. The platform notifies 40 such holders of intellectual property assets 32, makes them aware of a clustered interest and provides an opportunity for them to list their intellectual property assets.

Referring now to FIG. 4, the platform 10 comprises collaboration software 50 which allows similarly interested persons 12 and 14 who are also subscribers to the platform 10 to engage in dialogue 52 pertaining to subject matter of interest to them, in this example IP category A. Users can form clustered interests of their own creation to explore, evaluate and discuss the intellectual property assets in existence or that are required in a given field. These discussions can take place through one or more means including through a forum interface, wiki or blog, email, instant messaging/online chat, voice or videoconferencing means. Preferably, the collaboration aspects of the platform are open to all users of the internet on a subscription or non-subscription basis. However, the platform permits parties to designate their conversation as being public, restricted to a group of users, or private.

Based on the content analysis 24 of each discussion the search engine 57 continuously searches for intellectual property assets contained in its database 18 that are pertinent to the discussion. For example, if the discussion is about category “A” 56 of intellectual property then the platform will search the database 18 for IP assets in that category. Preferably, the intellectual property assets identified by the content analysis as being relevant to a discussion can be presented in the form of drop down lists that are made available 58 to the participants. As the discussion progresses the platform continues to refine its search and to generate lists on an ongoing basis. The platform allows one or more of the participants to identify an item of Subscriber IP as being of interest for the purpose of commercial discussions.

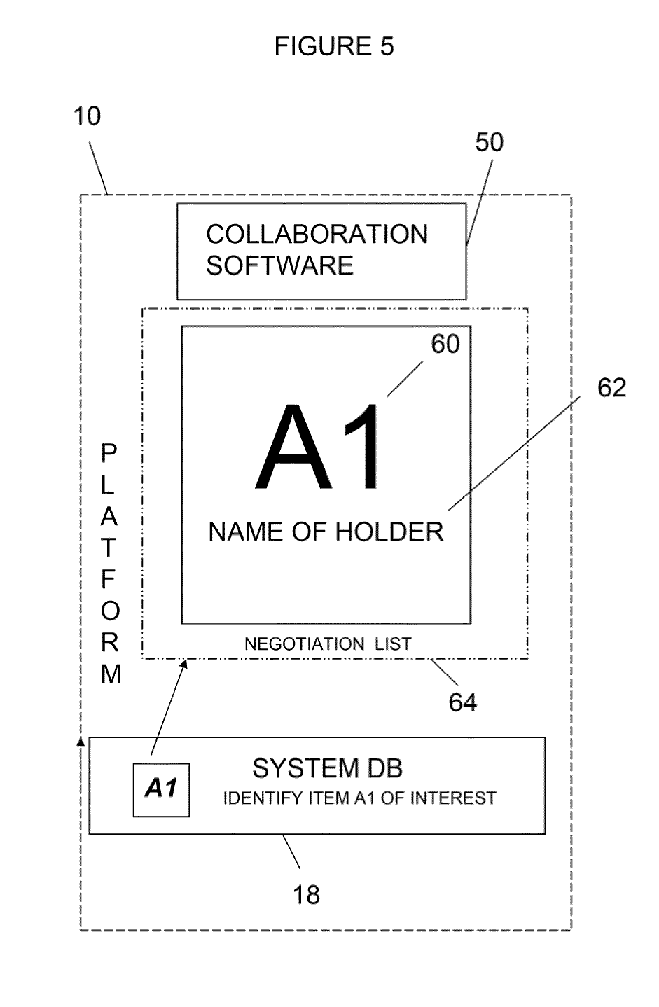

Referring now to FIG. 5, and in the case of Subscriber IP stored on database 18, once an intellectual property asset A1 60 is identified by the participants as being of interest, the A1 asset holder 62 is notified. Participants can permit the conversation to be exposed to the holder to start a commercialization discussion or to contact the holder themselves in a separate conversation.

Once an item A1 of Subscriber IP is identified on the platform as being of interest for the purpose of a commercial negotiation, the platform places the item on a negotiation list 64 which records the parties involved in the negotiation. Preferably, the contents of the negotiation list are internal to the platform and not made available to the public. However, it may be particularly advantageous for the platform to make public the level of interest pertaining to a given item of Subscriber IP at a given time.

The platform can allow a given item of Subscriber IP to appear on the negotiation list more than once at a given time. Alternatively, in a preferred embodiment an interested party can purchase a time limited exclusivity period for negotiation on payment of a fee.

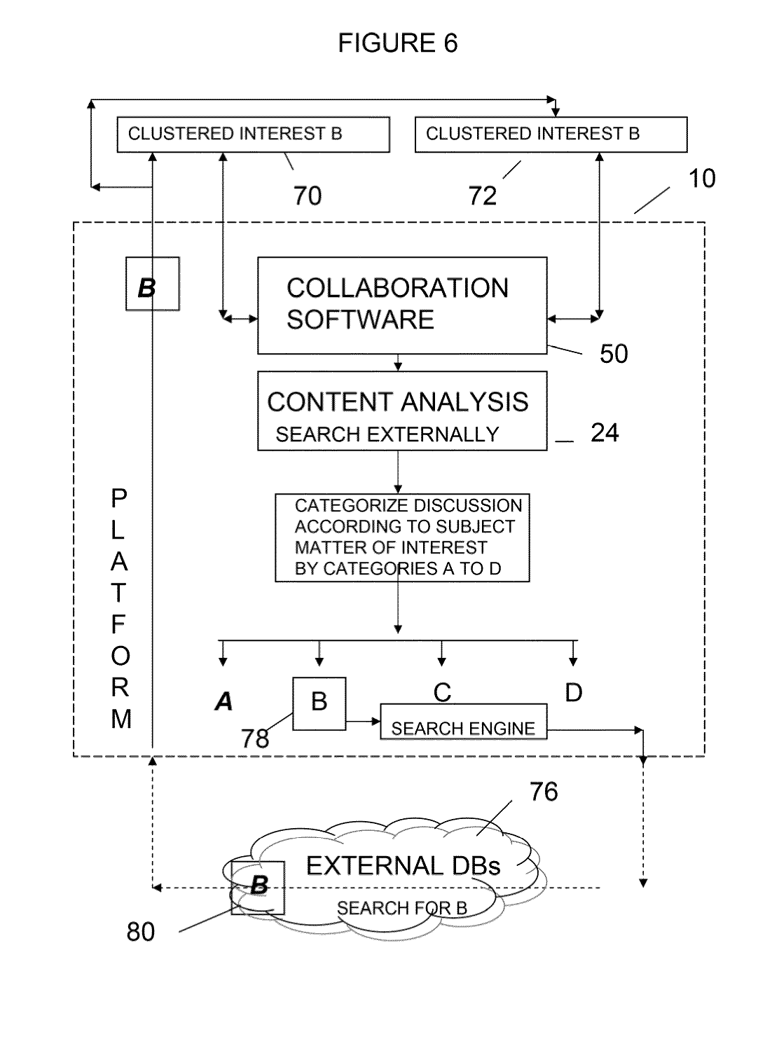

Referring now to FIG. 6, and in addition to accessing Subscriber IP stored in database 18, participants 70 and 72 belonging to cluster interest B may request the platform 10 to search for intellectual property assets listed in third party databases 76. For example, if the discussion is about IP category “B” then the content analysis software will identify the topic “B” 78 of interest and the platform will conduct a search of external third party databases for similar assets 80.

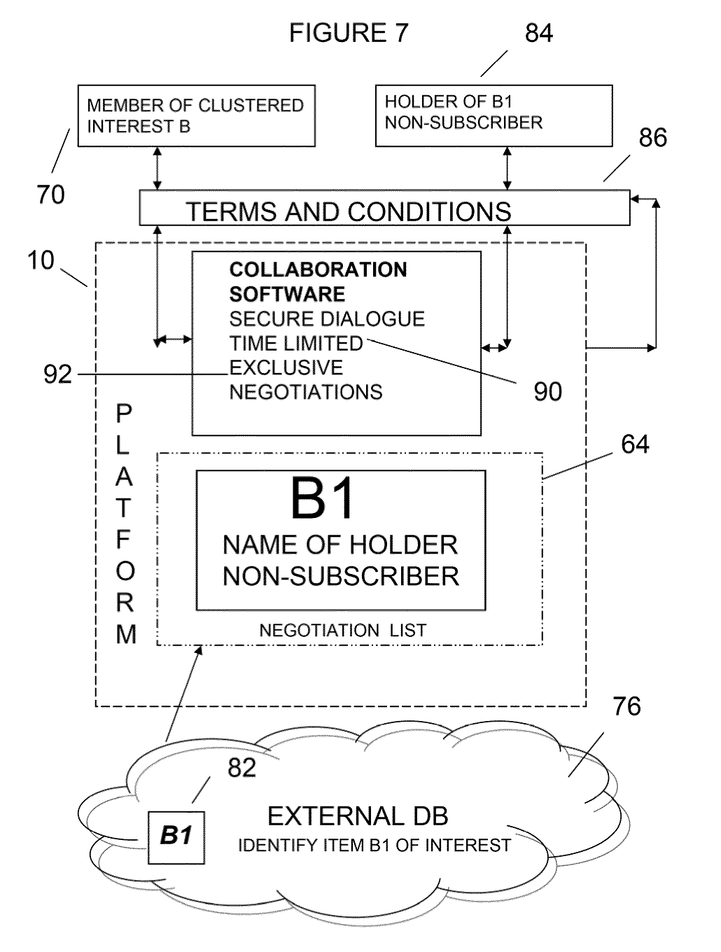

Referring now to FIG. 7, the platform is able to identify for the participants intellectual property assets 82 belonging to parties who have not yet listed their assets in its database (“Non-Subscriber IP”). Preferably, where the platform is asked to expose participants to Non-Subscriber IP which may be of interest to a discussion, it will contact the holder 84 of that IP asset directly and invite the holder to join the discussion. Also, prior to linking a holder of Non-Subscriber IP to a discussion, both the participants and the holder must agree to abide by the terms and conditions 86 of the platform in relation to any commercial negotiation. This may include that it be mandatory that the item of Non-Subscriber IP be automatically placed on the platform's negotiation list and remain there for a specified time limit 90 and for exclusive negotiations between the parties 92.

In a preferred embodiment, the participants to any commercial negotiation initiated by the platform must agree that intellectual property asset in question shall remain on the negotiation list pending consummation of transaction by the participants.

Further, preferably only the platform operator can remove an intellectual property asset from the negotiation list. The platform accepts request for the removal of an asset from the negotiation list, if for example one or both participants specify that they wish to terminate the negotiation. In this event, before removal of the asset from the negotiation list the platform may require that any future transaction between the parties be conditional on payment of all monies due to the platform operator under its listing agreement with the IP holder. Preferably, the platform automatically and periodically searches public records, including, for example, press releases, and assignment databases to verify compliance with the rules and conditions of the platform.

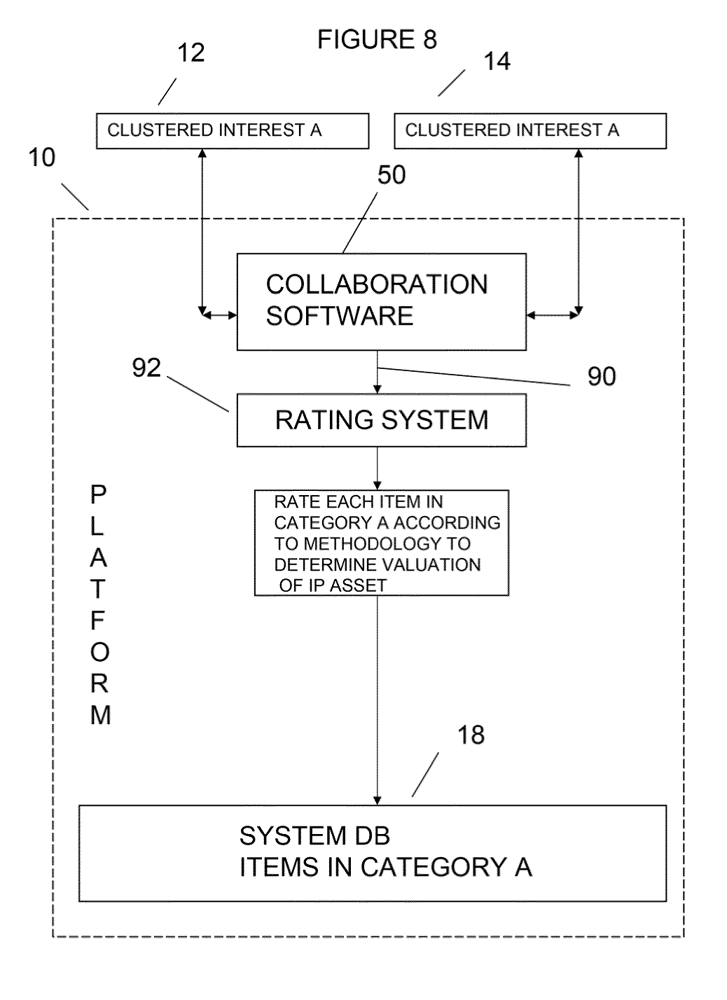

Referring now to FIG. 8, and in a preferred embodiment the platform participants 12 and 14 are able to rate 90 individual assets based on generic score carding methodologies 92 made available through the platform 10. Alternatively, specific clustered interests can elect to integrate into the platform their own score carding methodologies uniquely designed for their own needs. Further, where parties require third party assistance in the valuation of intellectual property assets from for example, professional valuators, lawyers or accountants the platform can allow them to invite this assistance into the discussion. In the case of legal professionals this assistance can also include providing on-line framework for contracts with electronic signature capacity as part of the discussion. Preferably, the IP holder may elect to have the rating of its intellectual property assets and conversations relating thereto made public or subject to pre-defined disclosure restrictions.

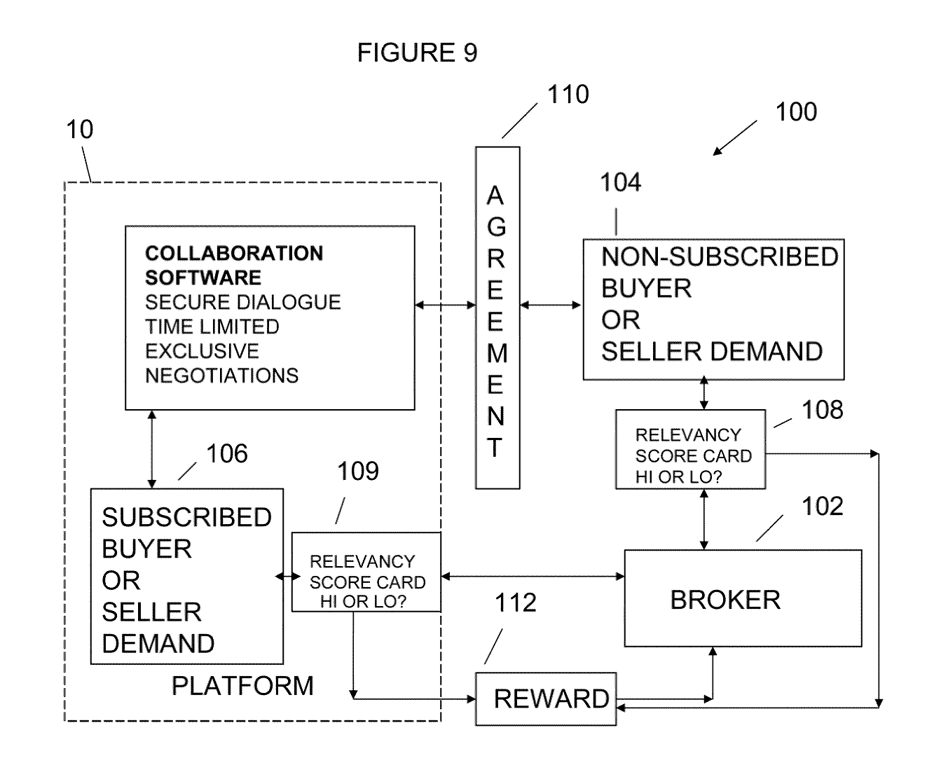

Referring to FIG. 9, the present invention also comprises a reward platform 100 for commercial discussion and topic generation participation by third parties brokers 102 who agree to work within the platform in linking buyers 104 and sellers 106 whether they be subscribes or non-subscribers. Non-subscribers must execute an agreement 110 to be bound by the terms of the platform 10. The interested brokers may include, for example, affiliates, aggregators, agents or patent attorneys. To participate such brokers can be invited to sign up to a rewards platform established by the IP holder, subject to such acceptance criteria as the IP holder may define. The reward platform includes relevancy score carding 108 and 109 and referral matching technique for arms length IP listings belonging to an IP holder. The IP holder can control broker commissions and exclusivity. For example, an IP holder can link the level of the reward 112 to the success of a given brokers based on the relevancy of opportunities they bring or whether a transaction is successfully consummated.

Further, the platform of the present invention allows brokers to sort by reward platform to compare both fixed and variable awards and create personal portfolios to expose and solicit to their communities of interest. The platform enables brokers to trade their personal portfolios of IP assets in which they have some form of exclusivity. In addition, annuity firms and firms with large portfolios are able to participate in the market established through the platform of the present invention by providing bid and joint ownership options for the assumption of renewal fees and even further filings.

Although the description above contains much specificity, these should not be construed as limiting the scope of the invention but as merely providing illustrations of some of the presently preferred embodiments of this invention. Thus the scope of the invention should be determined by the appended claims and their legal equivalents rather than by the examples given.

What is claimed is:

1. A social networking platform for intellectual property (IP) assets comprising:
a. A market comprising vendors and purchasers of said IP assets;
b. An e-commerce platform linking said vendors with said purchasers whereby the vendors upload proprietary IP assets for sale to said platform on a subscription basis and wherein the vendors and purchasers are grouped into a plurality of interest clusters related to their particular IP interests;
c. A content analysis engine for categorizing the IP assets into a plurality of searchable categories;
d. A database for storing said proprietary IP assets; and,
e. Messaging means for communication to plurality of said interest clusters the presence of IP assets of potential interest that are for sale.

2. The platform of claim 1 wherein the vendors and purchasers access said e-commerce platform on a subscription basis.

3. The platform of claim 1 further including means adapted to identify additional sources of vendible IP assets for interest clusters, wherein said additional sources of vendible IP assets are stored on external databases.

4. The platform of claim 1 further including communications means between interest clusters in order that they may discuss the sale of IP assets of interest for a pre-determined and limited period of time.

5. The platform of claim 4 further including a negotiation list upon which IP assets of interest, are placed so that vendors and purchasers of the IP assets of interest may negotiate a commercial transaction.

6. The platform of claim 5 further including means to extend said pre-determined and limited period of time for a fee.

7. The platform of claim 1 further including a reward platform for motivating individual sellers and vendors of IP to link vendors and purchasers in successful transactions.

8. The platform of claim 1, further including a third party broker for bringing subscribing and non-subscribing purchasers and sellers of IP to the platform.

9. The platform of claim 8, further including a reward platform for ranking the performance of said third party broker in meeting a set of purchase or sale desires of the vendor and purchaser.

10. The platform of claim 9, wherein said reward platform includes a relevancy card whereby the vendor and purchaser rates the performance of the third party broker between a spectrum of hi or lo relevancy score in meeting said set of purchase or sale desires.

11. The platform of claim 10, wherein said relevancy score determines the quantum of reward paid to the broker.

12. A subscription-based social networking platform for intellectual property (IP) assets comprising;
a. A market comprising at least a first and a second subscriber, wherein said at least first and second subscriber subscribe to said platform by payment of a fee;
b. A first set of vendible IP assets belonging to the at least first subscriber and a second set of vendible IP assets belonging to at least second subscriber;
e. An e-commerce platform for a purchase and sale of the at least one IP asset over a computer network, wherein said purchase and sale is available only to the at least first and second subscribers;
d. Communication means within said e-commerce platform for linking the at least first subscriber with the at least second subscriber to permit negotiations within the e-commerce platform in a secure manner;
e. A database for storing a plurality of IP vendible assets that are for purchase and sale;
f. An internet portal whereby the at least first subscriber uploads said first set of vendible IP assets into said database, and whereby the at least second subscriber uploads said second set of vendible IP assets into the database;
g. Content analysis means whereby the first set and the second set of vendible IP assets are analyzed to determine what category of a predetermined set of categories each asset of the first and second sets of IP assets belong; wherein said predetermined set of categories comprise patents, trade-marks, industrial designs, licensable patents and vendible patents;
h. A negotiations list for placement of an IP asset determined to be of interest to the at least first and the at least second subscriber for negotiating the purchase and sale thereof, wherein said IP asset determined to be of interest remains on said negotiations list for a limited period of time;

13. The platform of claim 12, wherein the at least first subscriber comprises a first plurality of subscribers having a first common interest in a first of said categories of IP assets thereby forming a first, interest cluster, and wherein the at least second subscriber comprises a second plurality of subscribers having a second common interest in a second of said, categories of IP assets thereby forming a second interest cluster, and further wherein there is a predetermined set of interest clusters matching said predetermined set of IP asset categories.

14. A method of establishing a networking platform for IP assets comprising the steps of:
a. Establishing a market for said IP assets wherein said market comprises vendors and purchasers who are subscribers to the platform;
b. Providing an e-commerce platform linking said vendors with said purchasers on a subscription basis;
c. Uploading IP for sale by subscribing vendors into a database;
d. Categorization said uploaded up into categories of interest to said subscribing vendors and purchasers;
e. Establishing interest clusters comprising vendors or purchasers of IP assets having a common IP asset interest comprising said categories of interest; and,
f. Providing messaging means for communication to said interest clusters the presence of IP assets for sale of interest to the interest clusters.

15. The method of claim 12, further including the step of permitting non-subscribing vendors and sellers to participate in the e-commerce platform.

16. The method of claim 13, further including the step of permitting third party brokers to facilitate the purchase and sale of IP assets through the e-commerce platform.

17. The method of claim 14, further including the step of incentivizing said third party brokers through a reward platform.

18. The method of claim 15, further comprising the step of creating a relevancy card and ranking the relevancy of the performance of the third party broker as a hi or lo relevancy score in meeting requirements of the vendor and purchaser.

19. The method of claim 16, further comprising the step of tying the reward to the third party broker to the relevancy score.
